(19) United States
(12) Patent Application Publication
(10) Pub. No.: US 2005/0069484 A1
(43) Pub. Date: Mar. 31, 2005

(54) Method of preparation of positive electrode material

(76) Inventors: Vesselin G. Manev, Flint, MI (US); Vijay P. Saharan, Grand Blanc, MI (US); Yee-Ho Chia, Troy, MI (US); Jeffrey L. Roberts, Saginaw, MI (US)

Correspondence Address: DELPHI TECHNOLOGIES, INC.;Legal Staff, Mail Code: 480-410-202, P.O. Box 5052, Troy, MI, 48007-5052, US

(21) Appl. No.: 10/675,552

(22) Filed: Sep. 30, 2003

(51) Int. Cl. C01D 1/02; C01G 51/04; C01G 53/04

(52) U.S. Cl. 423/594.15; 423/594.4; 423/594.6

(57) ABSTRACT

A method for preparing a positive electrode material for a lithium-ion or lithium-ion polymer battery to reduce the moisture content of the positive electrode material. A lithiated transition metal oxide positive electrode material having at least one water-containing compound therein is treated to convert the water-containing compound to a water-free compound. One treatment in the method of the present invention involves exposing the positive electrode material at a temperature of 0-650° C. to a CO₂-containing gas. The other treatment in the method of the present invention involves heating the positive electrode material to a temperature greater than 250° C. in the presence of an oxygen-containing gas, such as air and/or O₂. The treatments may be, performed sequentially or concurrently.

### RELATED APPLICATION

This application is related to commonly owned, co-pending U.S. patent application Ser. No. (DP-309342) filed on even date and entitled POSITIVE ELECTRODE MATERIAL FOR LITHIUM-ION BATTERY, the disclosure of which is incorporated herein by reference in its entirety as if completely set forth herein below.

### TECHNICAL FIELD

This invention relates to a method of preparation of lithium batteries, in particular, the positive electrodes of lithium-ion and lithium-ion polymer batteries.

### BACKGROUND OF THE INVENTION

Lithium-ion cells and batteries are secondary (i.e., rechargeable) energy storage devices well known in the art. The lithium-ion cell, known also as a rocking chair type lithium battery, typically comprises a carbonaceous negative electrode that is capable of intercalating lithium-ions, a lithium-retentive positive electrode that is also capable of intercalating lithium-ions, and a separator impregnated with non-aqueous, lithium-ion-conducting electrolyte therebetween.

The negative carbon electrode comprises any of the various types of carbon (e.g., graphite, coke, mesophase carbon, carbon fiber, etc.) which are capable of reversibly storing lithium species, and which are bonded to an electrically conductive current collector (e.g., copper foil) by means of a suitable organic binder (e.g., polyvinylidene difluoride, PVDF, PE, PP, etc.).

The positive electrode comprises such materials as transition metal chalcogenides that are bonded to an electrically conductive current collector (e.g., aluminum foil) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂ and LiNiO₂, their solid solutions and/or their combination with other metal oxides.

The electrolyte in such lithium-ion cells comprises a lithium salt dissolved in a non-aqueous solvent which may be (1) completely liquid, (2) an immobilized liquid, (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polyfluorides and polycarbonates, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into the pores of the positive and negative electrode and in a separator layer between the positive and negative electrode. The separator may be a porous polymer material such as polyethylene, polyfluoride, polypropylene or polyurethane, or may be glass material, for example, containing a small percentage of a polymeric material, or may be any other suitable ceramic or ceramic/polymer material.

Lithium-ion cells made from pure polymer electrolytes, or liquid electrolytes entrapped in a polymer matrix, are known in the art as “lithium-ion polymer” cells, and the electrolytes therefore are known as polymeric electrolytes. Lithium-polymer cells are often made by laminating thin films of the negative electrode, positive electrode and separator together wherein the separator layer is sandwiched between the negative electrode and positive electrode layers to form an individual cell, and a plurality of such cells are bundled together to form a higher energy/voltage battery.

During the charge process in these lithium-ion rechargeable batteries, lithium-ions are deintercalated (or released) from the positive electrode and are intercalated (or inserted) into layer planes of the carbonous material. During the discharge, the lithium-ions are released from the negative electrode and are inserted into the positive electrode. For a proper function of this rocking chair type charge-discharge mechanism, the surface compositions and properties of both positive and negative electrodes intercalation compound are of substantial importance. In a battery or a cell utilizing lithium-containing intercalation compounds, it is important to eliminate as many impurities as possible that may affect cell performance. The main impurity that contributes to increased cell impedance and decreased cell capacity is water and products generated from reaction of the water with cell electrolyte as HF (hydrogen fluoride). Water may be introduced in the cell as physically bound water during the process of cell preparation, but can also be incorporated as water-containing compounds, which may release water in the cell by a change in equilibrium or by reaction with other cell products during the cell life.

The lithium-ion battery with a lithiated transition metal oxide based positive electrode, and in particular with a nickel-based compound of the general formula LiNi_{X}CO_{Y}M_{Z}O₂, where M is a transition metal or the sum of transition metals different than Ni and Co, has the highest specific energy among the currently known lithium-ion batteries. However, to ensure a highly ordered structure and respectively good capacity and cycle life, an excess of lithium and/or transition metal compounds than the stoichiometric amount is ,used during the synthesis of the positive electrode material. Typically, an excess of lithium is between 5-10 mole %, but it can also vary from 1-30 mole % based on the total moles of transition metals. These excess lithium compounds and/or transition metal compounds may contain a significant amount of chemically bound water which can be released during the cell life. It is believed that the excess lithium and/or transition metals form hydroxides and carbonates. For example, excess lithium is believed to form a composite of lithium hydroxide (LiOH), lithium carbonate (Li₂CO₃) and lithium bicarbonate (LiHCO₃) in the final product with a varying range of ratios, depending on the synthesis and the storage conditions. For example, LiOH may be the main component of the lithium excess for a freshly synthesized material, while LiHCO₃ may be the main component of the lithium excess after being stored at ambient atmosphere. It is thus believed that the nickel-cobalt-based-positive electrode material prepared with excess lithium is more precisely expressed with the formula:
LiNi_{X}Co_{Y}M_{Z}O₂.(LiOH(Li₂CO₃)ₘ(LiHCO₃)ₙ
where M represents a transition metal or a sum of transition metals different from Ni and Co and where X+Y+Z=1, X≧Y, Z<0.5 and 0.001<k+m+n<0.3.

The presence of LiOH and LiHCO₃ compounds in the lithium excess composite is believed to significantly increase the moisture in the cell. For example, the presence of LiHCO₃ may generate moisture in the cell during the cell's life according to the equilibrium:
2LiHCO₃→Li₂CO₃+CO₂+H₂O
while the LiOH may react with the existing CO₂ in the cell to generate moisture according to the reaction:
2LiOH+CO₂→Li₂CO₃+H₂O
CO₂ is a main product of the self discharge of both positive and negative electrodes in lithium and lithium-ion batteries, such that moisture generation is highly likely in the presence of any LiOH. Also, LiOH, which is a typical impurity in the nickel-based positive electrode materials, is highly hygroscopic and may absorb a significant amount of moisture during positive electrode and cell preparation processes. Other possible water-containing compounds present in a battery cell having a positive electrode therein that was prepared with excess transition metal include transition metal hydroxides and basic transition metal carbonates, such as the basic nickel-carbonate 2NiCO₃.3Ni(OH)₂, which will also contribute to high moisture content in the battery.

The negative effects of moisture in lithium and lithium-ion batteries is well established. It has been shown that the moisture increases the self discharge of both positive and negative electrodes and strongly reduces the cycle and calendar life of the cell. Additionally, because part of the self discharge products are gasses, an increase in the moisture content significantly increases the cell gassing, which may cause fast cell deterioration, particularly for soft pack cells.

There is thus a need for a method of preparing lithium-ion and lithium-ion polymer batteries having reduced cell moisture content, and in particular, a method for preparing the positive electrode material to reduce moisture-containing compounds, particularly those that are strongly bound to the positive electrode active material.

### SUMMARY OF THE INVENTION

The present invention provides a method for preparing a positive electrode material for a lithium, lithium-ion or lithium-ion polymer battery to reduce the moisture contenting compounds of the positive electrode material, thereby improving the cycle life and calendar life of the lithium-ion cells and significantly decreasing gassing during the cycle or calendar life. To this end, a lithiated transition metal oxide positive electrode material having at least one water-containing compound therein, such as a lithium hydroxide, lithium bicarbonate, transition metal hydroxide and/or basic transition metal carbonate, is subjected to treatments to convert the water-containing compound to a water-free compound. One treatment in the method of the present invention involves exposing the positive electrode material at a temperature of 0-650° C. to a CO₂-containing gas having a partial pressure in the range of 0.0001-100 atm. This treatment is effective to convert lithium hydroxides, for example, to lithium carbonate, which is a water-free compound. The other treatment in the method of the present invention involves heating the positive electrode material to a temperature greater than 250° C., advantageously up to 650° C., in the presence of an oxygen-containing gas, such as air and/or O₂. This treatment is effective to decompose lithium bicarbonate and basic nickel carbonate, for example, to lithium carbonate and nickelous oxide, respectively, which are water-free compounds. This treatment is most effective when performed immediately before the positive electrode and cell preparation. This treated positive electrode material may then be processed to form a positive electrode film and laminated with a current collector, a separator and a negative electrode, and then activated with electrolyte to form a battery cell having a reduced cell moisture content.

In an exemplary embodiment of the present invention, a nickel-based positive electrode material is prepared using an excess of lithium to form a lithiated nickel-based oxide with the excess in the form of lithium compounds including LiOH, Li₂CO₃ and LiHCO₃. Thereafter, the positive electrode material is exposed at a temperature of 0-650° C. to a CO₂-containing gas having a partial pressure in the range of 0.0001-100 atm to convert the water-containing LiOH compound to water-free Li₂CO₃ and, either concurrently or thereafter, the positive electrode material is heated to a temperature greater than 250° C., advantageously up to 650° C., in the presence of an oxygen-containing gas, such as air and/or O₂ to convert the water-containing LiHCO₃ and 2NiCO₃.3Ni(OH)₂ compounds to water-free Li₂CO₃, NiCO₃, NiO, Ni₂O₃ and LiNiO₂.

### BRIEF DESCRIPTION OF THE DRAWINGS

The present invention will now be described, by way of example, with reference to the accompanying drawings, in which:

FIG. 1 is a graph of weight loss as a function of temperature, as measured by TGA (thermogravimetric analysis), for a fresh positive electrode material and an aged positive electrode material;

FIG. 2 is a graph of weight loss as a function of temperature, as measured by the Karl Fischer technique, for an aged positive electrode material, compared to the respective TGA measurement;

FIG. 3 is a graph of weight loss and heat flow as a function of temperature, as measured by DSC (differential scanning calorimetry), for an aged positive electrode material, compared to the respective TGA measurement;

FIG. 4 is a graph of the derivative weight loss and heat flow as a function of temperature, as measured by TGA and DSC;

FIG. 5 is a graph of weight gain as a function of time for a fresh positive electrode material exposed to CO₂ gas; and

FIG. 6 is a graph of moisture and carbon dioxide evolution rate as a function-of time for a positive electrode material exposed at 500° C., as measured selectively by MS (mass spectrometer);

FIG. 7 is a graph of cycle life performance of a cell with positive electrode prepared in accordance with the present invention versus a reference cell;

FIG. 8 is a graph of calendar life performance of cells with positive electrode prepared in accordance with the present invention versus reference cells;

FIG. 9 is a graph of cycle life performance of cells with positive electrode prepared in accordance with the present invention versus reference cells; and

FIG. 10 is a graph of calendar life performance of cells with positive electrode prepared in accordance with the present invention versus reference cells.

### DETAILED DESCRIPTION

The present invention provides a method for removing selectively chemically bound water from the surface of positive electrode compounds. Specifically, the present invention treats positive electrode materials having water-containing compounds therein to convert those compounds to water-free compounds. One treatment in the method of the present invention involves reacting the positive electrode material with carbon dioxide gas to convert the water-containing LiOH compound to a water-free compound at a temperature in the range of 0-650° C. The CO₂-containing gas has a partial pressure of CO₂ in the range of 0.0001-100 atm. Advantageously, the positive electrode materials are exposed to the CO₂-containing gas at a temperature of 100-400° C., and more advantageously, at a temperature of 100-300° C. Also advantageously, the CO₂-containing gas has a partial pressure of CO₂ in the range of 0.0002-0.2 atm, and more advantageously, 0.0004-0.04 atm.

Another treatment of the method of the present invention releases moisture, i.e., water-containing compounds, by heat treating the positive electrode material at a temperature of at least 250° C. in the presence of an oxygen-containing gas, such as air, having a partial pressure of O₂ in the range of 0.01-99 atm. Advantageously, the positive electrode material is heat treated at a temperature in the range of 250-650° C., and more advantageously, at a temperature of 300-450° C. Also advantageously, the oxygen-containing gas has a partial pressure of O₂ in the range of 0.01-1.0 atm. Air, for example, typically has an oxygen partial pressure of about 0.2 atm. During the heat treatment, the water-containing compounds bound in the positive electrode material are thermally decomposed to release the moisture. Some water-containing compounds thermally decompose by evolution of water, and others thermally decompose by evolution of water and carbon dioxide gas. The oxygen-containing gas, though not necessary to initiate the thermal decomposition of the water-containing compounds, does contribute to maintaining the stability of the main lithiated transition metal oxide compound that forms the active positive electrode material (e.g., LiNi_{X}Co_{Y}M_{Z}O₂) during the treatment.

In one embodiment of the present invention, the positive electrode material is subjected to both treatments concurrently. With concurrent treatment, the positive electrode material is heated to a temperature of 250-650° C. and exposed concurrently to CO₂-containing gas and oxygen-containing gas. Advantageously, the temperature range for the concurrent treatment is 250-500° C., and even more advantageously, in the range of 300-450° C. In another embodiment of the present invention, the positive electrode material is subjected to both treatments sequentially. More specifically, the positive electrode material may be first treated by exposing the material to a CO₂-containing gas at a temperature of 0-650° C., followed by heating the material to a temperature of at least 250° C. in the presence of an oxygen-containing gas.

The method of the present invention is directed to treating lithiated transition metal oxide-based positive electrode materials. An exemplary positive electrode material is one having the formula LiNi_{X}Co_{Y}M_{Z}O₂, where M is a transition metal or the sum of transition metals different than Ni and Co, and X+Y+Z=1, X≧Y and Z<0.5 because batteries containing a positive electrode comprising such material has the highest specific energy among the currently known lithium-ion batteries. However, other lithiated transition metal compounds may also be used. The following is a list of possible lithiated transition metal oxides that may form a positive electrode treated by the method of the present invention, though this list is not intended to be exhaustive: LiCoO₂, LiNiO₂, LiNi_{0.5}Co_{0.5}O₂, LiCo_{1/3}Ni_{1/3}Mn_{1/3}O₂, LiNi_{1-X-Y}CO_{X}Mn_{Y}O₂, LiNi_{1-X-Y}Co_{X}Al_{Y}O₂, LiNi_{1-X-Y-z}Co_{X}Ti_{Y}Mg_{Z}O₂, LiFePO₄, LiCoPO₄, LiVPO₄, LiFeO₂, Li₃V₂(PO₄)₃, LiVP₂O₇, LiV₃O₈, and Li₃CrMnO₅. The lithiated transition metal compounds are prepared with an excess of lithium, and possibly with an excess of the transition metal. These excess metals form into one or more compounds, at least some of which may be water-containing compounds such as lithium hydroxide, lithium bicarbonate, transition metal hydroxides and basic transition metal carbonates. Because these types of compounds absorb significant amounts of moisture during storage or contact with ambient atmosphere, the present invention treats the material to remove such compounds prior to the electrode and cell preparation. The best results are obtained if the treatment is performed immediately before electrode and cell preparation. Water-free compounds, such as lithium carbonate and transition metal oxides do not contribute to any significant extent, if at all, to moisture content in the cell, such that conversion of water-containing compounds to these essentially water-free compounds by the method of the present invention will significantly improve capacity retention during the cycle life and the calendar life of the lithium-ion cells and decrease gassing during the calendar life of the battery. The overall reduction of cell moisture by this method also reduces the cell impedance and increase cell power substantially.

As stated above, it has been found that strongly bound moisture in water-containing compounds can be released by heat treatment at temperatures of at least 250° C. in the presence of an oxygen-containing gas having a partial pressure of O₂ in the range of 0.01-99 atm. For example, lithium bicarbonate is a water-containing compound, which can be expressed as 2LiHCO₃=Li₂CO₃.H₂O.CO₂. Upon heat treatment in accordance with the present invention, lithium bicarbonate thermally decomposes by evolution of water and carbon dioxide according to the following reaction:
2LiHCO₃→Li₂CO₃+H₂O+CO₂
Another possible water-containing compound may be the basic nickel carbonate 2NiCO₃.3Ni(OH)₂ which also decomposes by evolution of water and carbon dioxide according to the following reaction:
2NiCO₃.3Ni(OH)₂.5NiO+3H₂O+2CO₂
Another possible water-containing compound may be cobaltous hydroxide Co(OH)₂, which decomposes by evolution of water according to the following reaction:
Co(OH)₂→CoO+H₂O
Another possible water-containing compound may be nickelous hydroxide Ni(OH)₂, which also decomposes by evolution of water according to the following reaction:
Ni(OH)₂→NiO+H₂O
Yet another possible water-containing compound may be the basic chromic carbonate, which decomposes by evolution of water and carbon dioxide according to the reaction:
CH₂Cr₂O₆→Cr₂O₃+CO₂+H₂O
During the thermal decomposition of these types of compounds, the oxygen-containing gas, such as air or O₂, maintains the stability of the active positive electrode material.

As further stated above, reaction of the positive electrode material at a temperature of 0-650° C. with a CO₂-containing gas having a partial pressure of CO₂ in the range of 0.0001-100 atm will convert other water-containing compounds to water-free compounds while releasing the strongly bound water. One possible water-containing compound that may be reactive with carbon dioxide to produce water and a water-free compound is lithium hydroxide, according to the following formula:
LiOH+CO₂→Li₂CO₃+H₂O
Another possible water-containing compound that may be reactive with carbon dioxide to produce water and a water-free compound is basic cobaltous carbonate, according to the following formula:
C₂H₆Co₅O₁₂+3CO₂→5CoCO₃+3H₂O

Thus, lithium hydroxide and lithium bicarbonate are treated to release water and produce the water-free lithium carbonate compound, and transition metal hydroxides and basic transition metal carbonates are treated to produce transition metal oxides and water-free transition metal carbonates. For example, for a positive electrode material prepared with an excess of lithium having the formula:
LiNi_{X}Co_{Y}M_{Z}O₂.(LiOH)ₖ(Li₂CO₃)ₘ(LiHCO₃)ₙ
where M represents a transition metal or a sum of transition metals different from Ni and Co and where X+Y+Z=1, X≧Y, Z<0.5 and 0.001<k+m+n<0.3, the treatment of the present invention converts the LiOH and the LiHCO₃ to the Li₂CO₃ compound, thereby reducing the values of k and n and increasing the value of m. The treatment methods of the present invention also convert impurities that exist as basic cobaltous carbonate C₂H₆Co₅O₁₂ and basic nickelous carbonate C₂H₆Ni₅O₁₂, which are typical reaction products of LiNi_{X}Co_{Y}M_{Z}O₂ with ambient atmosphere during handling and shelf life, to water-free compounds NiCO₃, NiO, CoO, Ni₂O₃, LiNO₂ and/or LiCoO₂. The method of the present invention is effective to convert at least a portion of the excess water-containing compounds to water-free compounds, and advantageously, all water-containing compounds are converted to water-free compounds to release all chemically combined moisture from the positive electrode material.

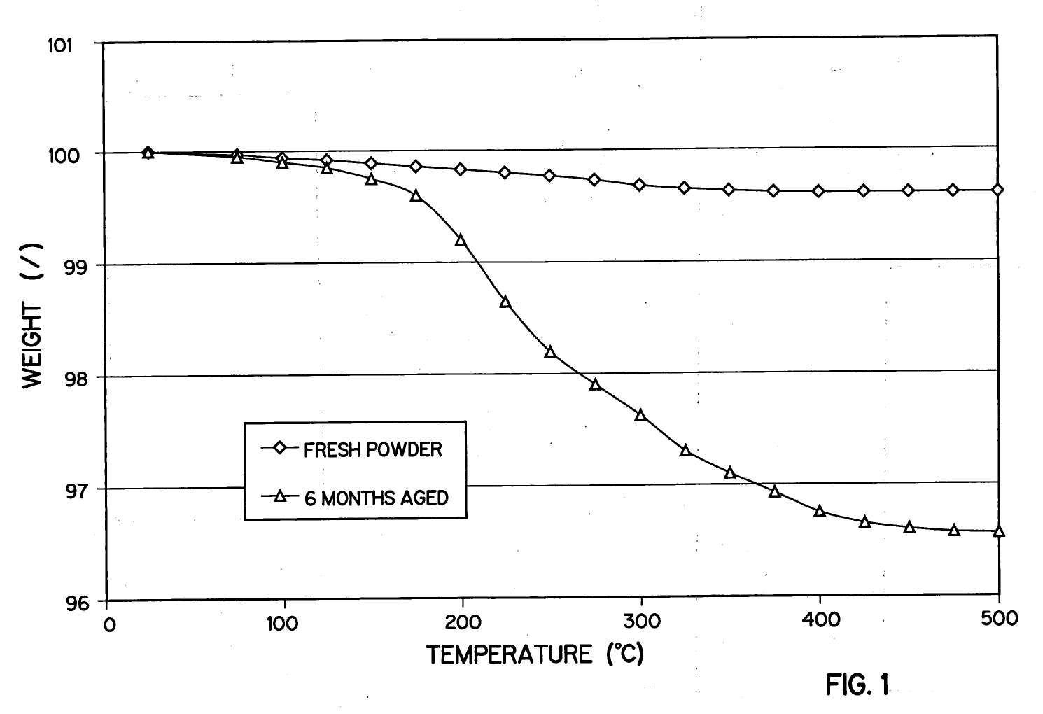

Turning to the figures, FIG. 1 demonstrates the effect of the treatment method of the present invention in-which the positive electrode material is treated to thermally decompose water-containing compounds. The treatment was applied both to a fresh positive electrode material and a positive electrode material that had been stored in an ambient atmosphere for six months. As discussed above, excess lithium is likely in the form of LiOH for a freshly synthesized positive electrode material, and LiHCO₃ for a positive electrode material that has been stored at ambient atmosphere. The positive electrode material tested was of the LiNi_{X}Co_{Y}M_{Z}O₂ type. Measurements were taken by thermogravimetric analysis (TGA), well known to persons skilled in the art, at 5° C./min in oxygen. For this test, both the fresh and aged electrode materials showed weight loss up to 400° C. or more, and the loss was more significant for the aged compound.

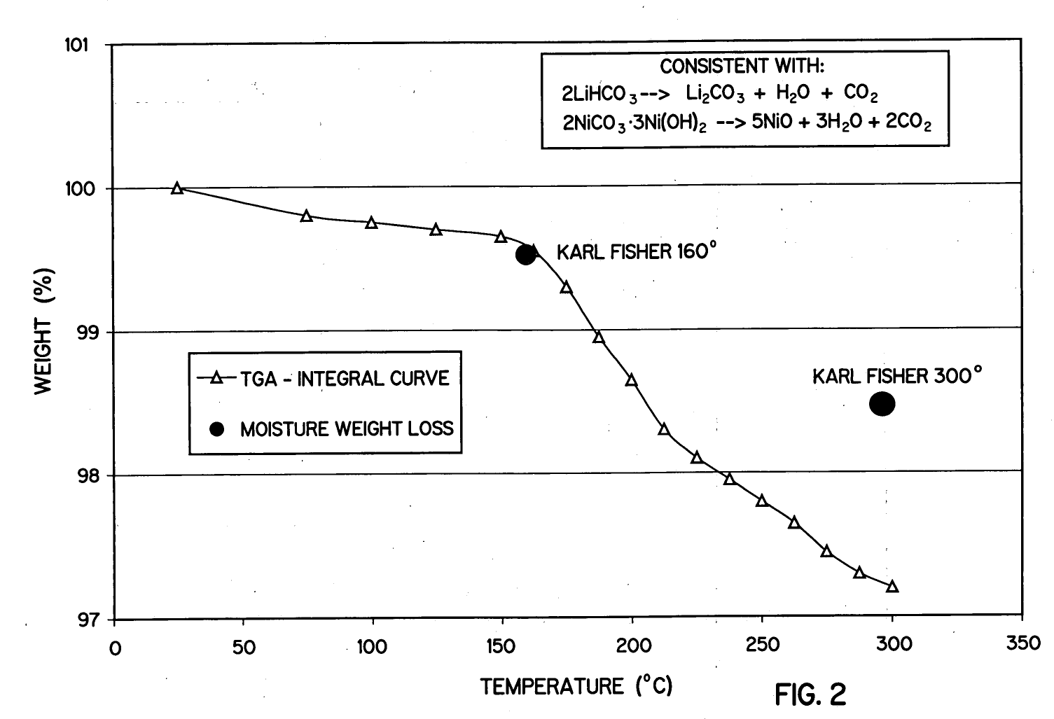

The Karl Fischer titration method, also well known to persons skilled in the art, is the best method for measuring moisture content. Thus, FIG. 2 depicts the weight loss as a function of temperature for the aged positive electrode material, as measured by both the TGA method and the Karl Fischer method. FIG. 2 demonstrates that, up to 160° C., moisture is the only component of the percentage weight loss, while at about 300° C., the weight loss is only partly due to moisture evolution. Additional infrared measurement indicates that the other part of the weight loss is caused by CO₂ evolution. This is consistent with the supposition that at least part of the moisture is in the form of bicarbonate or basic carbonate, which are thermally decomposed by simultaneous evolution of H₂O and CO₂.

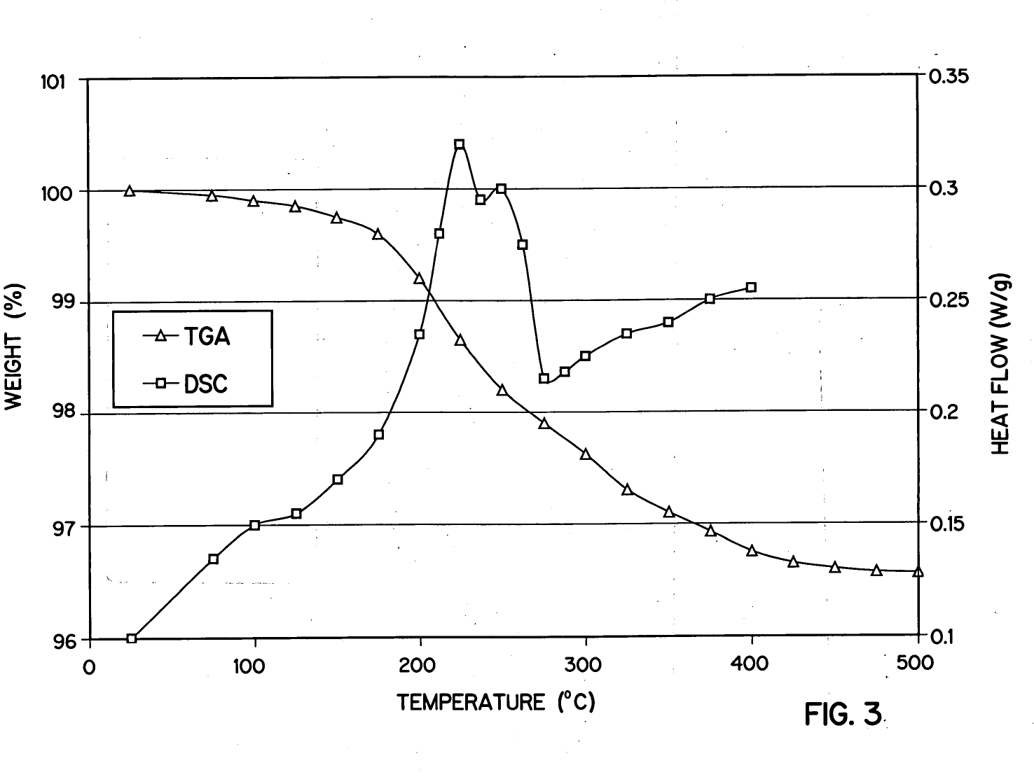

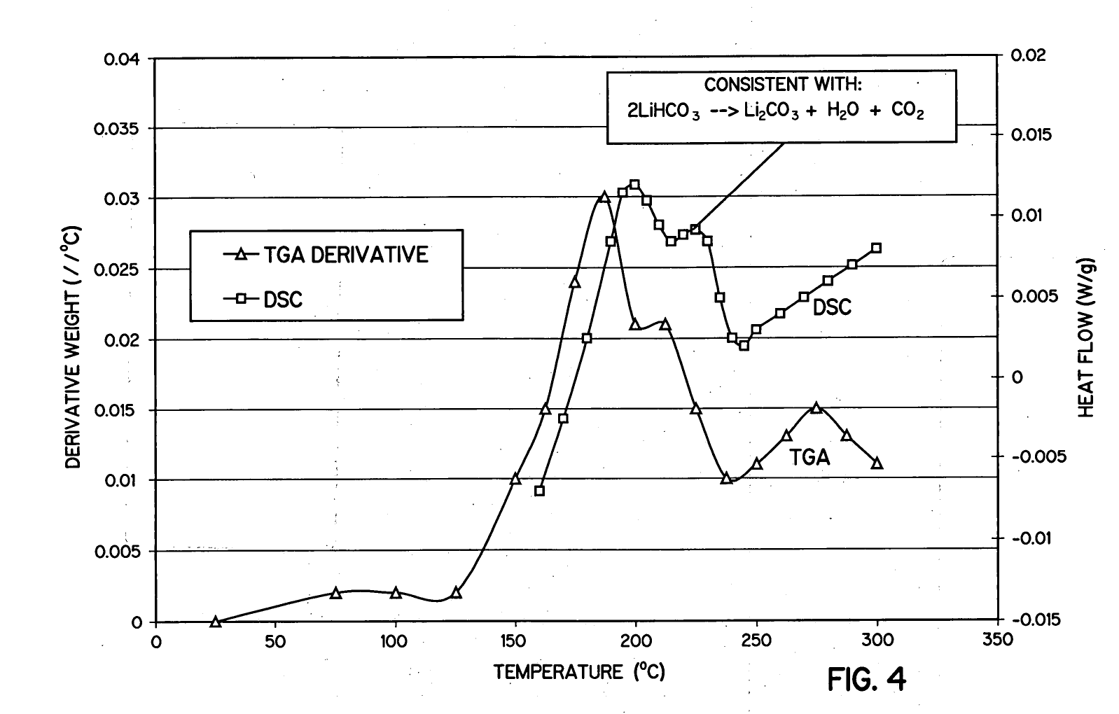

Another measurement is differential scanning calorimetry (DSC), well known to persons skilled in the art, and which shows a peak when one material phase changes to another material phase; i.e., one crystal structure to another crystal structure, with corresponding heat exchange. Referring to FIG. 3, the aged positive electrode material was measured by both TGA and DSC, and this data suggests that the weight loss is associated with the phase transition, as would be expected due to thermal decomposition of the bicarbonate or basic carbonate phases. More precise TGA derivative and DSC measurements at 1° C./min are provided in FIG. 4. This data confirms that the phase transition closely follows the derivative of the weight loss curve, which suggests that the chemically combined water is associated with the phase transition, which can be completed only at a temperature essentially higher than 250° C.

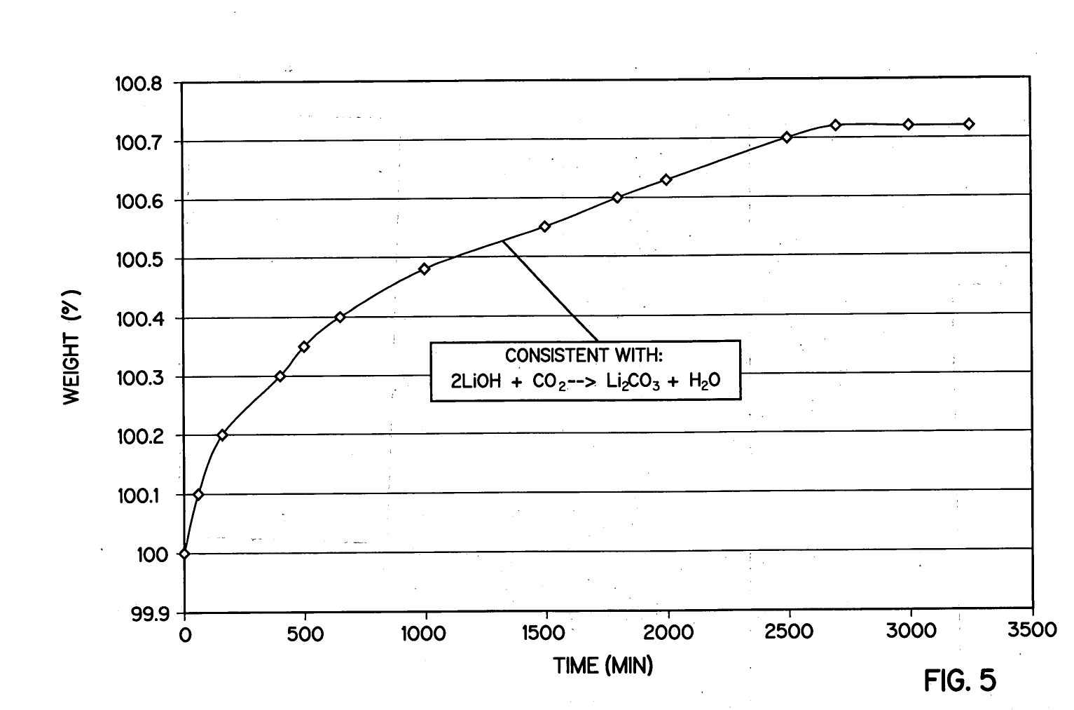

Regarding the treatment in which the positive electrode material is exposed to a CO₂-containing gas having a partial pressure of CO₂ in the range of 0.0001-100 atm at a temperature of 0-650° C., FIG. 5 shows TGA data where fresh LiNi_{X}Co_{Y}M_{Z}O₂ positive electrode material is heated to a temperature of 100° C. in a 50% CO₂ and 50% air gas mixture, and maintained at the constant temperature for a period of time with periodic measurement. The sample weight significantly increases over time, which is in agreement with the conversion of the LiOH water-containing compound to water-free Li₂CO₃ and H₂O. Thus, the CO₂ treatment can be used for partly or completely converting the existing LiOH impurities on the positive electrode material to Li₂CO₃.

It has further been found that the rate of the LiOH conversion reaction increases significantly with increases in temperature and the partial pressure of CO₂. However, with an increase in temperature and partial pressure of CO₂, undesirable reactions between the main compounds of the lithiated transition metal oxide and CO₂ gas may take place, such that proper selection of the temperature and partial pressure of CO₂ is important for optimal electrochemical performance of the positive electrode material. The use of lower partial pressures of CO₂ at higher temperature is desirable.

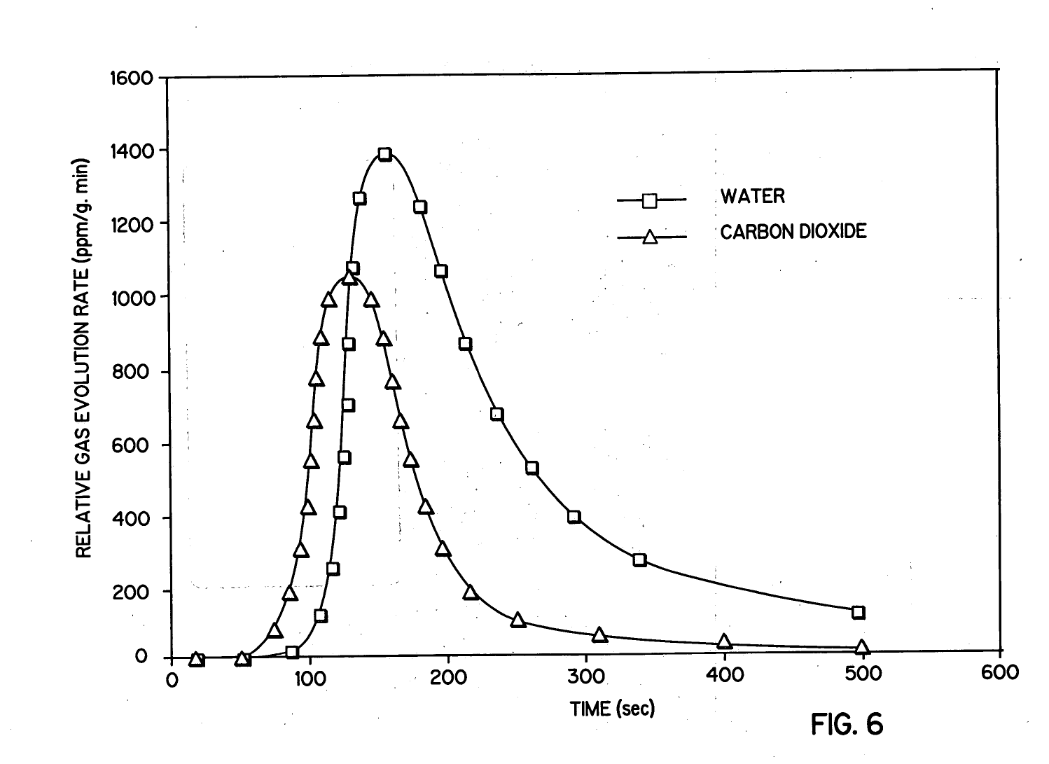

FIG. 6 shows the water and carbon dioxide evolution rate as a function of time for a positive electrode material treated in accordance with the present invention at 500° C., as measured selectively by MS (mass spectrometer). The water vapor and carbon dioxide evolution rates are very close and the amount of the two gases, which correspond to the areas closed between the curves and X-axis, are comparable. This data confirms the suggestion made from the TGA and DSC measurement described earlier that the combined moisture in the positive electrode material is mainly as bicarbonate and basic carbonate phases.

### EXAMPLE 1

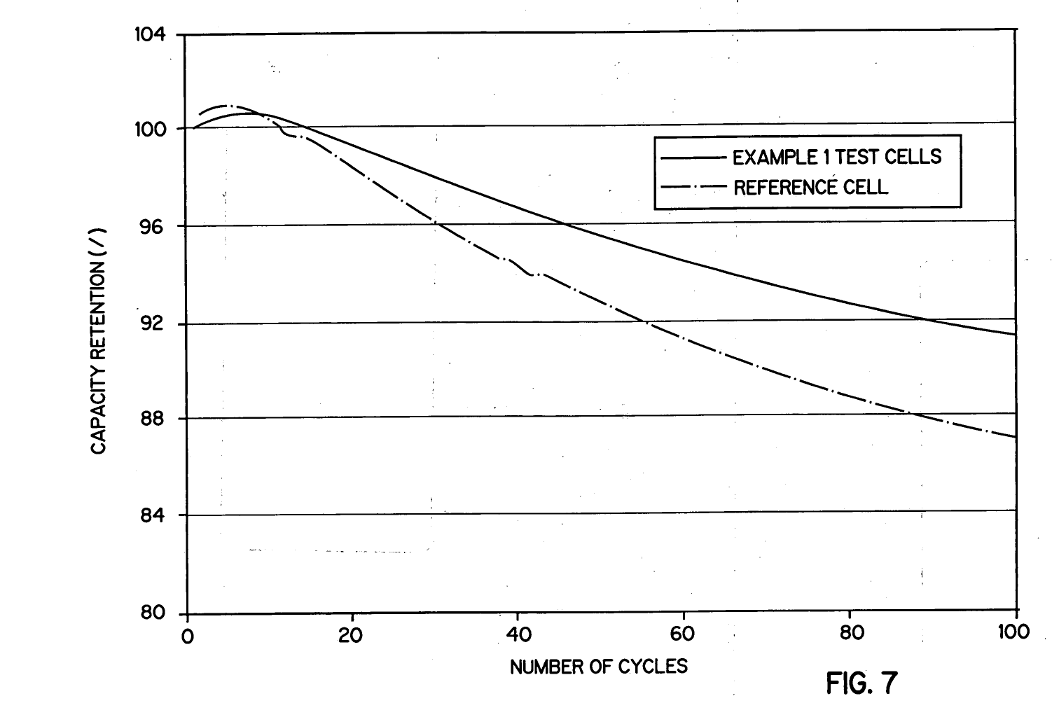

A lithium-ion PVDF polymer 20 cm² Bellcore-type test cell was used where the positive electrode was treated in accordance with the present invention. An Al doped LiCo_{0.2}Ni_{0.8}O₂ positive electrode and a natural graphite negative electrode were used for cell preparation. The LiCo_{0.2}Ni_{0.8}O₂ positive electrode material was first heated at 100° C. with an air/CO₂ mixture containing 50% CO₂ for 18 hours and then heated at 300° C. for 8 hours in accordance with the present invention. The treatment was performed immediately before positive electrode preparation. The two electrodes were separated with a polypropylene-based polymer separator. The cell was activated with 1 M LiPF₆ electrolyte dissolved in EC:EMC (ethylene carbonate:ethyl-methyl carbonate). The cell was then hermitically closed and electrochemically formed by 3 cycles at a charge-discharge rate of C/5 (i.e., current=cell capacity/5 hours). The cell was then subjected to cycle life characterization at 55° C. using a C/2 charge-discharge rate. The cycle life performance of the cell prepared using the method of the present invention is shown in FIG. 7.

A reference cell with the same chemistry described above but with a positive electrode material utilized as received (i.e., not treated by the method of the present invention) was used for comparative measurement. The cell was activated with the same 1 M LiPF₆ dissolved in EC:EMC electrolyte. The cell was then closed and formed by 3 cycles at a charge-discharge rate of C/5. The cell was then subjected to cycle life characterization at 55° C. using the C/2 charge-discharge rate, as with the cell prepared according to the present invention. The reference cell cycle life performance is also shown in FIG. 7. The cell with treated positive electrode material according to the present invention exhibits substantially lower capacity fade during the cycle life test than the reference cell.

### EXAMPLE 2

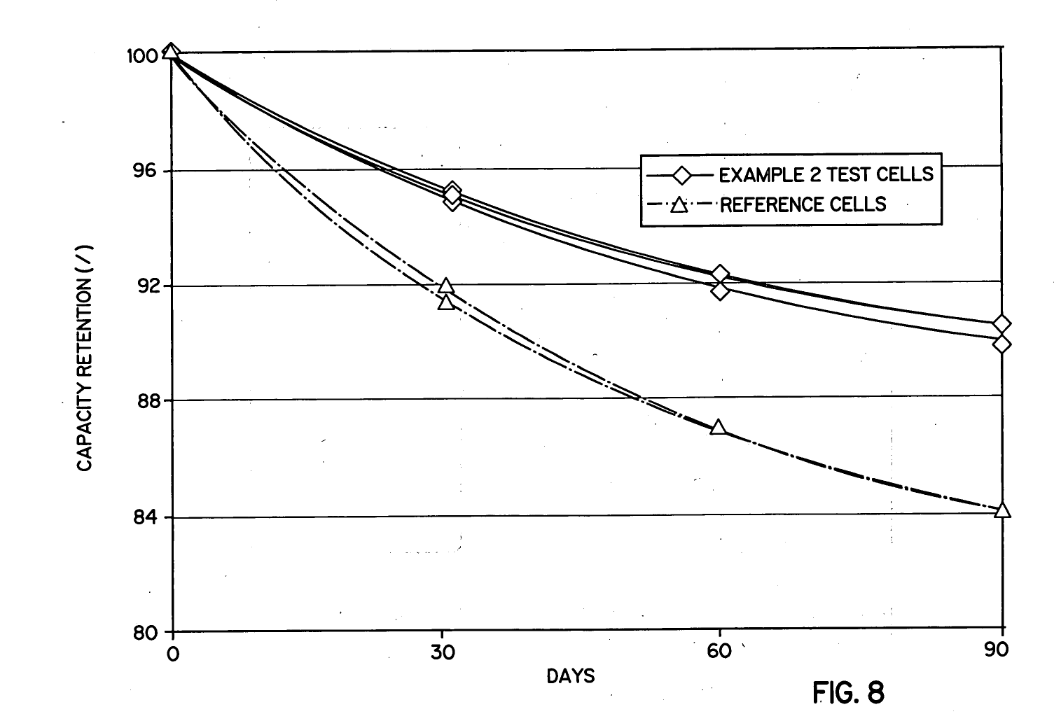

Lithium-ion PVDF polymer 20 cm² experimental cells were prepared according to the present invention as described in Example 1, but with the Al doped LiCo_{0.2}Ni_{0.8}O₂ positive electrode material first heated at 100° C. with an air/CO₂ mixture containing 1% CO₂ for 18 hours and than heated at 300° C. for 8 hours immediately before positive electrode preparation in accordance with the present invention. The cells were then subjected to calendar life characterization at 55° C. using a C/2 charge-discharge rate. The calendar life performance of the cells prepared using the method of the present invention is shown in FIG. 8.

Reference cells with the same chemistry described above but with a positive electrode material used as received were used for comparative measurement. The cells were subjected to calendar life characterization at 55° C. and a C/2 rate, as with the cell with treated positive electrode material according to the present invention. The calendar life performance of these reference cells is also shown in FIG. 8. The cells with treated positive electrode material according to the present invention exhibit substantially better capacity retention than the reference cells during the calendar life test.

### EXAMPLE 3

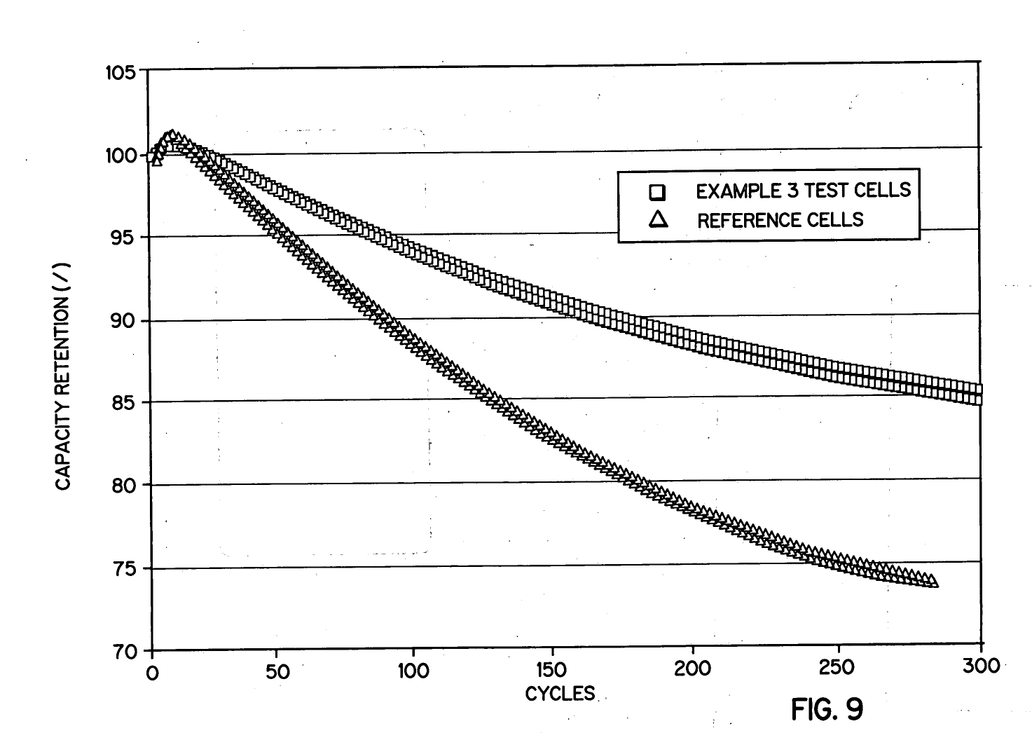

Lithium-ion PVDF polymer 20 cm² experimental cells were prepared according to the present invention as described in Example 1, but with the positive electrode material treated with a gas mixture containing 1% CO₂, 21% O₂ and 78% N₂ for 24 h at 300° C. The cells were then subjected to cycle life characterization at 55° C. and a C/2 rate. The cycle life-performance of the cells prepared using the method of the present invention is shown in FIG. 9.

Reference cells with the same chemistry described above but with a positive electrode material used as received were used for comparative measurement. The cells were subjected to cycle life characterization at 55° C. using a C/2 charge-discharge rate, as with the cells prepared according to the present invention. The cycle life performance of the reference cells is also shown in FIG. 9. The cell with treated positive electrode material according to the present invention exhibits substantially better cycle life performance than the reference cell.

### EXAMPLE 4

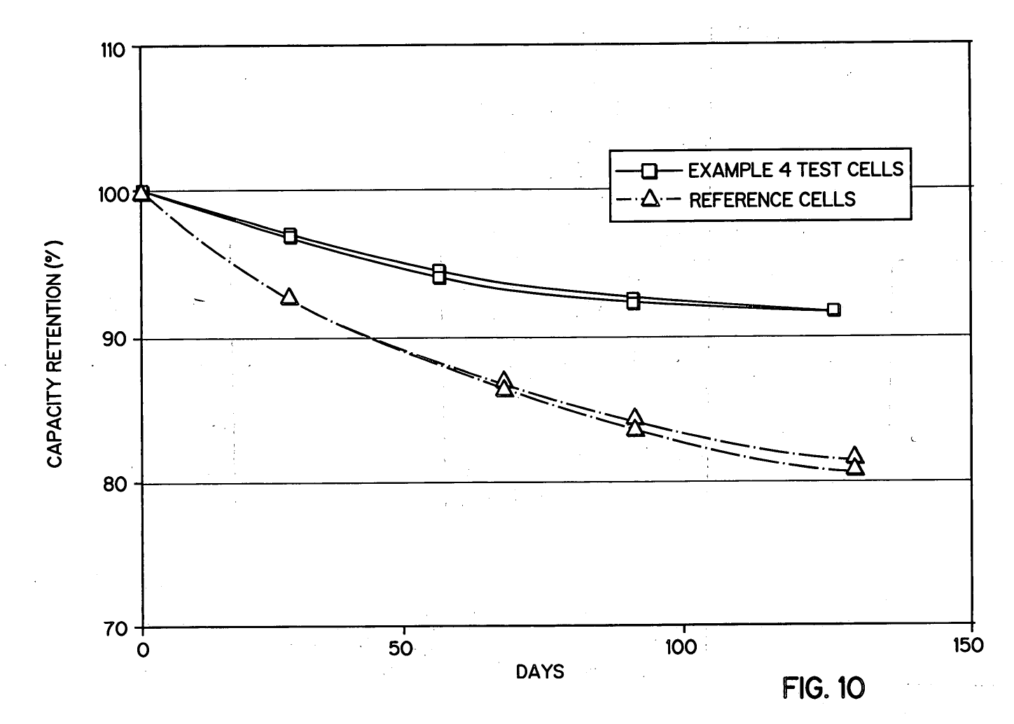

Lithium-ion PVDF polymer 20 cm² experimental cells were prepared according to the present invention as described in Example 1, but with LiCo_{0.2}Ni_{0.8}O₂ positive electrode material heated at 300° C. for 96 hours and simultaneously intensively flowed with air containing about 0.05% C0₂. The cells were then subjected to calendar life characterization at 55° C. and a C/2 rate. The calendar life performance of the cells prepared using the method of the present invention is shown in FIG. 10.

Reference cells with the same chemistry described above but with a positive electrode material as received were used for comparative measurement. The cells were subjected to calendar life characterization at 55° C. using a C/2 rate, a with the cells prepared with treated positive electrode material according to the present invention. The calendar life performance of these reference cells is also shown in FIG. 10. The cells prepared according to the present invention have a significantly lower capacity loss during the calendar life test and respectively longer calendar life than the untreated reference cells.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

1. A method for preparing a positive electrode material for use in a cell of a lithium, lithium-ion or lithium-ion polymer battery, the method comprising subjecting a lithiated transition metal oxide positive electrode material having one or more water-containing compounds therein to a treatment prior to preparing said cell to convert at least a portion of the water-containing compounds to one or more water-free compounds, wherein the treatment includes the following:
(a) exposing the positive electrode material at a temperature of 0-650° C. to a CO₂-containing gas having a partial pressure of CO₂ in the range of 0.0001-100 atm; and
(b) heating the positive electrode material to a temperature of at least 250° C. in the presence of an oxygen-containing gas having a partial pressure of O₂ in the range of 0.01-99 atm.

2. The method of claim 1 wherein the one or more water-containing compounds are selected from the group consisting of LiOH, LiHCO₃, 2NiCO₃.3Ni(OH)₂ and Ni(OH)₂ and the one or more water-free compounds are selected from the group consisting of Li₂CO₃, NiCO₃, NiO, Ni₂O₃ and LiNiO₂.

3. The method of claim 1 wherein the one or more water-containing compounds are selected from the group consisting of a lithium hydroxide, a lithium bicarbonate, a transition metal hydroxide and a basic transition metal carbonate.

4. The method of claim 1 wherein the CO₂-containing gas of treatment (a) has a partial pressure of CO₂ in the range of 0.0002-0.2 atm.

5. The method of claim 1 wherein the CO₂-containing gas of treatment (a) is air.

6. The method of claim 1 wherein the oxygen-containing gas of treatment (b) has a partial pressure of O₂ in the range of 0.1-1.0 atm.

7. The method of claim 6 wherein the oxygen-containing gas of treatment (b) is air.

8. The method of claim 1 wherein the oxygen-containing gas of treatment (b) is air.

9. The method of claim 1 wherein the positive electrode material is subjected to treatment (a) at a temperature of 100-400° C.

10. The method of claim 1 wherein the positive electrode material is subjected to treatment (b) at a temperature of 250-650° C.

11. The method of claim 1 wherein the positive electrode material is subjected first to treatment (a), then to treatment (b).

12. The method of claim 1 wherein the positive electrode material is subjected simultaneously to treatments (a) and (b) at a temperature in the range of 250-650° C.

13. The method of claim 12 wherein the temperature is in the range of 300-500° C.

14. The method of claim 12 wherein the CO₂-containing gas has a partial pressure of CO₂ in the range of 0.0002-0.2 atm, and the oxygen-containing gas is air with a partial pressure of O₂ in the range of 0.1-1.0 atm.

15. The method of claim 1 wherein the positive electrode material is subjected to treatment (b) immediately prior to preparing said cell.

16. A method for preparing a positive electrode material for use in a cell of a lithium, lithium-ion or lithium-ion polymer battery, the method comprising:
preparing a lithium-based positive electrode material with an excess of lithium, wherein the excess lithium forms at least one water-containing compound selected from the group consisting of LiOH and LiHCO₃;
exposing the positive electrode material at a temperature of 0-650° C. to a CO₂-containing gas having a partial pressure of CO₂ in the range of 0.0001-100 atm for a time sufficient to react at least a portion of LiOH with CO₂ to produce Li₂CO₃; and
immediately prior to preparing said cell, heating the positive electrode material to a temperature of at least 250° C. in the presence of an oxygen-containing gas having a partial pressure of O₂ in the range of 0.01-99 atm for a time sufficient to thermally decompose at least a portion of LiHCO₃ to produce Li₂CO₃.

17. The method of claim 16 wherein the CO₂-containing gas has a partial pressure of CO₂ in the range of 0.0002-0.2 atm.

18. The method of claim 16 wherein the oxygen-containing gas has a partial pressure of O₂ in the range of 0.1-1.0 atm.

19. The method of claim 18 wherein the oxygen-containing gas is air.

20. The method of claim 16 wherein the temperature for exposing the positive electrode material to the CO₂-containing gas is in the range of 100-400° C.

21. The method of-claim 16 wherein the temperature for heating the positive electrode material in the presence of the oxygen-containing gas is in the range of 250-650° C.

22. The method of claim 16 wherein the positive electrode material is heated and exposed to the CO₂-containing gas and the oxygen-containing gas simultaneously at a temperature in the range of 250-650° C.

23. The method of claim 22 wherein the temperature is in the range of 300-500° C.

24. A method for preparing a positive electrode material for use in a cell of a lithium, lithium-ion or lithium-ion polymer battery, the method comprising:
preparing a positive electrode material of the formula LiNi_{X}Co_{Y}M_{Z}O₂.(LiOH)ₖ(Li₂CO₃)ₘ(LiHCO₃)ₙ wherein M is one or more transition metals different than Ni and Co, X+Y+Z=1, X≧Y, Z<0.5, 0.01<k+m+n<0.3 and k, m and n each have a first value; and
thereafter, and prior to preparing said cell, subjecting the positive electrode material to the following treatments:
(a) exposing the positive electrode material at a temperature of 0-600° C. to a CO₂-containing gas having a partial pressure of CO₂ in the range of 0.0001-100 atm; and
(b) heating the positive electrode material to a temperature of at least 250° C. in the presence of an oxygen-containing gas having a partial pressure of O₂ in the range of 0.01-99 atm,
wherein, after subjecting the positive electrode material to the treatments, at least one of k and n has a second value less than the respective first value, and m has a second value greater than the respective first value.

25. The method of claim 24 wherein treatment (b) is performed at a temperature of 250-650° C.

26. The method of claim 24 wherein the positive electrode material is subjected first to treatment (a), then to treatment (b).

27. The method of claim 24 wherein the positive electrode material is subjected simultaneously to treatments (a) and (b) at a temperature in the range of 250-650° C.

28. The method of claim 27 wherein the temperature is in the range of 300-500° C.

29. The method of claim 24 wherein treatment (a) is performed at the partial pressure of CO₂ in the range of 0.0002-0.2 atm.

30. The method of claim 24 wherein treatment (b) is performed at the partial pressure of CO₂ in the range of 0.1-1.0 atm.

31. A method for preparing a positive electrode material for use in a cell of a lithium, lithium-ion or lithium-ion polymer battery, the method comprising:
preparing a positive electrode material of the formula LiNi_{X}Co_{Y}M_{Z}O₂.(LiOH)ₖ(Li₂CO₃)ₘ(LiHCO₃)ₙ wherein M is one or more transition metals different than Ni and Co, X+Y+Z=1, X≧Y, Z<0.5, 0.01<k+m+n<0.3 and k, m and n each have a first value;
exposing the positive electrode material at a temperature of 250-650° C. to a CO₂-containing gas having a partial pressure in the range of 0.0002-0.2 atm; and
immediately prior to preparing said cell, heating the positive electrode material to a temperature of at least 250-650° C. in the presence of an oxygen-containing gas having a partial pressure of O₂ in the range of 0.1-1.0 atm,
wherein, after exposing and heating the positive electrode material, k and n each have a second value less than the respective first value, and m has a second value greater than the respective first value.
